(19) United States
(12) Patent Application Publication
(10) Pub. No.: US 2011/0062379 A1
(43) Pub. Date: Mar. 17, 2011

(54) NEGATIVE ELECTRODE FOR NONAQUEOUS ELECTROLYTE SECONDARY BATTERIES AND LITHIUM ION SECONDARY BATTERY

(76) Inventors: Satoru MIYAWAKI, Annaka-shi (JP); Yoshiyasu Yamada, Annaka-shi (JP); Toshio Ohba, Annaka-shi (JP); Tadao Ikeda, Tokyo (JP); Kazuhiro Sunouchi, Tokyo (JP)

(21) Appl. No.: 12/880,799

(22) Filed: Sep. 13, 2010

(30) Foreign Application Priority Data
Sep. 14, 2009 (JP) 2009-211257

(51) Int. Cl. H01M 4/134

(52) U.S. Cl. 252/182.1

(57) ABSTRACT

A negative electrode comprising (A) particles having Si dispersed in SiO, and (B) a polyamide-imide resin which contains amide and imide groups in an amide/imide ratio of 25/75 to 99/1 and has a weight average molecular weight of 10,000-200,000 is suited for nonaqueous electrolyte secondary batteries. The electrode exhibits a high 1st cycle charge/discharge efficiency and improved cycle performance while maintaining a high battery capacity and a low volume expansion.

### CROSS-REFERENCE TO RELATED APPLICATION

This non-provisional application claims priority under 35 U.S.C. §119(a) on Patent Application No. 2009-211257 filed in Japan on Sep. 14, 2009, the entire contents of which are hereby incorporated by reference.

### TECHNICAL FIELD

This invention relates to a negative electrode for use in nonaqueous electrolyte secondary batteries and a lithium ion secondary battery comprising the same.

### BACKGROUND ART

In conjunction with the recent rapid advances of portable electronic equipment and communications instruments, nonaqueous electrolyte secondary batteries having a high energy density are strongly demanded from the aspects of cost, size and weight reductions. Approaches known in the art to increase the capacity of such nonaqueous electrolyte secondary batteries include, for example, use as negative electrode material of oxides of B, Ti, V, Mn, Co, Fe, Ni, Cr, Nb, and Mo and composite oxides thereof (JP 3008228 and JP 3242751); application as negative electrode material of M₁₀₀₋ₓSiₓ wherein x≧50 at % and M=Ni, Fe, Co or Mn which is obtained by quenching from the melt (JP 3846661); use as negative electrode material of silicon oxide (JP 2997741); and use as negative electrode material of Si₂N₂O, Ge₂N₂O or Sn₂N₂O (JP 3918311).

Among others, silicon oxide is represented by SiOₓ wherein x is slightly greater than the theoretical value of 1 due to oxide coating, and is found on X-ray diffractometry analysis to have the structure that nano-size silicon ranging from several to several tens of nanometers is finely dispersed in silicon oxide. Silicon oxide particles can be converted to particles having Si dispersed in SiO₂ by heat treating silicon oxide powder in an inert non-oxidizing atmosphere at a temperature of at least 400° C. to effect disproportionation reaction whereby microcrystals of silicon with a controlled size are dispersed in the SiO₂ matrix. The particles having Si dispersed in SiO₂ are believed ready for use as the negative electrode active material because the battery capacity of these particles is smaller than that of silicon, but greater than that of carbon by a factor of 5 or 6 on a weight basis, and the particles experience a relatively less volume expansion.

Electrodes may be prepared by adding a binder such as polyvinylidene fluoride or polyimide to particles having Si dispersed in SiO₂. The electrode exhibits poor cycle performance in that its reversible capacity decreases after iteration of charge/discharge cycles several times when the binder is polyvinylidene fluoride (PVdF) used as the standard in the electrochemistry. When the binder is polyimide (inclusive of a polyamic acid which becomes polyimide upon heating), the cycle performance is improved, but the 1st cycle efficiency is as low as about 70%. This means that the positive electrode is required to have an extra battery capacity when a battery is actually fabricated. Then an increase of battery capacity corresponding to the 5 or 6-fold capacity increase per active material weight is not expectable. Negative electrodes comprising carbon or an alloy as the negative electrode material and a polyamide-imide resin as the binder were proposed in JP-A H11-102708, JP-A H11-126612, JP 3422390, JP 3422391, JP 3422392, and JP 3422389. It has never been attempted to apply polyamide-imide resins to silicon-base negative electrode materials. It is described in JP-A 2009-152037 that a polyamide-imide resin may be used in silicon oxide base negative electrode materials. However, specific examples using a polyamide-imide resin are nowhere described.

The practical problem of particles having Si dispersed in SiO₂ resides in the substantially low 1st cycle efficiency. The problem may be overcome by making up the irreversible fraction of capacity or by restraining the irreversible capacity. For example, the method of previously doping silicon oxide with Li metal is reported effective for making up the irreversible fraction of capacity. Doping of lithium metal may be carried out by attaching a lithium foil to a surface of negative electrode active material (JP-A 11-086847) or by vapor depositing lithium on a surface of negative electrode active material (JP-A 2007-122992). As for the attachment of a lithium foil, a thin lithium foil that matches with the 1st cycle efficiency of a negative electrode comprising particles having Si dispersed in SiO₂ is hardly available or prohibitively expensive if available. The deposition of lithium vapor makes the fabrication process complex and is impractical.

Aside from lithium doping, it is also disclosed to enhance the 1st cycle efficiency of negative electrode by increasing a weight proportion of Si. One method is by adding silicon particles to particles having Si dispersed in SiO₂ to reduce the weight percentage of oxygen (JP 3982230). In another method, silicon vapor is generated and precipitated in the same stage as is produced silicon oxide, obtaining mixed solids of silicon and silicon oxide (JP-A 2007-290919).

Silicon as an active material has both a high 1st cycle efficiency and a high battery capacity as compared with particles having Si dispersed in SiO₂, but displays a percent volume expansion as high as 400% upon charging. Even when silicon is added to a mixture of particles having Si dispersed in SiO₂ and carbonaceous material, the percent volume expansion of particles having Si dispersed in SiO₂ is not maintained, and eventually at least 20 wt % of carbonaceous material must be added in order to suppress the battery capacity at 1,000 mAh/g. The method of obtaining the mixed solids by simultaneously generating silicon and silicon oxide vapors suffers from the working problem that the low vapor pressure of silicon necessitates the process at a high temperature in excess of 2,000° C.

### Citation List

Patent Document 1: JP 3008228

Patent Document 2: JP 3242751

Patent Document 3: JP 3846661

Patent Document 4: JP 2997741

Patent Document 5: JP 3918311

Patent Document 6: JP-A H11-102708

Patent Document 7: JP-A H11-126612

Patent Document 8: JP 3422390

Patent Document 9: JP 3422391

Patent Document 10: JP 3422392

Patent Document 11: JP 3422389

Patent Document 12: JP-A 2009-152037

Patent Document 13: JP-A H11-086847

Patent Document 14: JP-A 2007-122992

Patent Document 15: JP 3982230

Patent Document 16: JP-A 2007-290919

### SUMMARY OF INVENTION

An object of the invention is to provide a negative electrode for use in nonaqueous electrolyte secondary batteries, comprising particles having Si dispersed in SiO₂ as an active material, which exhibits a high 1st cycle charge/discharge efficiency and improved cycle performance while maintaining a high battery capacity and a low volume expansion. Another object is to provide a lithium ion secondary battery using the same.

As discussed above, particles having Si dispersed in SiO₂ constitute a negative electrode active material which has a high battery capacity surpassing carbonaceous materials and minimizes a change of volume expansion inherent to silicon based negative electrode active materials, but suffers from a lowering of 1st cycle charge/discharge efficiency. The inventors made efforts to search for a binder which is combined with the active material (i.e., particles having Si dispersed in SiO₂) to obviate its drawback of a low 1st cycle charge/discharge efficiency. A polyimide binder (inclusive of a polyamic acid which becomes polyimide upon heating) was found to have good cycle performance, but to cause a lowering of 1st cycle efficiency because the polyimide itself can react with lithium. On the other hand, a polyvinylidene fluoride or similar binder (other than polyimide) which is less reactive with lithium was found to improve the 1st cycle efficiency, but to cause a lowering of cycle performance. Quite unexpectedly, the inventors have found that improvements in both 1st cycle charge/discharge efficiency and cycle performance are achieved using a specific polyamide-imide resin as the binder. When a battery is constructed using the negative electrode, the positive electrode which is otherwise required in excess can be reduced. An increase of battery capacity and a reduction of expensive positive electrode ensure industrial low-cost manufacture of nonaqueous electrolyte secondary batteries.

In one aspect, the invention provides a negative electrode for nonaqueous electrolyte secondary batteries, comprising (A) particles having Si dispersed in SiO₂ and (B) a polyamide-imide resin which contains amide and imide groups in an amide/imide ratio of 25/75 to 99/1 and has a weight average molecular weight of at least 10,000.

In a preferred embodiment, the particles (A) are further coated with carbon.

In a preferred embodiment, components (A) and (B) are present in an amount of 70 to 99.9% by weight and 0.1 to 30% by weight based on the weight of the electrode, respectively.

A lithium ion secondary battery comprising the negative electrode is also provided.

### ADVANTAGEOUS EFFECTS OF INVENTION

The negative electrode comprising particles having Si dispersed in SiO₂, as an active material and a polyamide-imide resin as a binder exhibits a high 1st cycle charge/discharge efficiency and improved cycle performance while maintaining a high battery capacity and a low volume expansion. It is suited for use in nonaqueous electrolyte secondary batteries. A lithium ion secondary battery using the negative electrode performs well.

### DESCRIPTION OF EMBODIMENTS

As used herein, the “average particle size” refers to a weight average particle size in particle size distribution measurement by the laser diffraction scattering method.

The negative electrode for nonaqueous electrolyte secondary batteries according to the invention is defined as comprising (A) particles having Si dispersed in SiO₂ and (B) a polyamide-imide resin which contains amide and imide groups in an amide/imide ratio of from 25/75 to 99/1 and has a weight average molecular weight of at least 10,000.

### A) Particles Having Si Dispersed In SiO₂

The particles are capable of occluding and releasing lithium ions. In the particles, silicon micro-particles are dispersed in SiO₂ matrix. Silicon micro-particles preferably has a particle size of 0.1 to 50 μm, more preferably 1 to 20 μm.

The particles having Si dispersed in SiO₂ are used as an active material in the negative electrode for nonaqueous electrolyte secondary batteries. Suitable methods for preparing the particles include a method (1) involving the step of firing a mixture of silicon fine particles and a silicon base compound, and a method (2) involving the steps of heating a mixture of silicon dioxide and metallic silicon to form a silicon monoxide gas, cooling the gas for allowing amorphous silicon oxide to precipitate (or heating an organosilicon compound to form a silicon monoxide gas, cooling the gas for allowing amorphous silicon oxide to precipitate), and then heat treating the amorphous silicon oxide at a temperature of at least 400° C. for effecting disproportionation reaction. Method (2) is preferred since particles having silicon micro-crystals uniformly dispersed are obtainable.

It is possible to dope the particles having Si dispersed in SiO₂ (A) with a hetero element which is typically selected from the group consisting of Ni, Mn, Co, B, P, Fe, Sn, In, Cu, S, Al, and C. Such doping may be effected at the same time when silicon oxide is prepared by heating a mixture of silicon dioxide and metallic silicon to form a silicon monoxide gas, and cooling the gas for precipitation of silicon oxide. For example, a hetero element is admixed in the mixture of silicon dioxide and metallic silicon, a compound of silicon and a hetero element is used as the metallic silicon, or a compound doped with a hetero element is used as the silicon dioxide.

The particles having Si dispersed in SiO₂ as component (A) are formed such that a molar ratio of oxygen/silicon is slightly greater than the theoretical value of 1, that is, 1.0<oxygen/silicon (molar ratio)<1.1. By etching the thus formed particles in an acidic atmosphere, only SiO₂ can be selectively removed from the particles. By the selective removal of only SiO₂, a range of 0.2<oxygen/silicon (molar ratio)<1.1 is possible. The acidic atmosphere used herein may be either an aqueous solution or an acid-containing gas while its composition is not particularly limited. Examples include hydrofluoric acid, hydrochloric acid, nitric acid, hydrogen peroxide, sulfuric acid, acetic acid, phosphoric acid, chromic acid, and pyrophosphoric acid, which may be used alone or in admixture of two or more. The treatment temperature is not particularly limited. By the treatment mentioned above, particles having Si dispersed in SiO₂ and meeting the range of 0.2<oxygen/silicon (molar ratio)<1.1 are available.

To impart electric conductivity, the particles (A) are preferably surface coated with carbon. Coated particles may be formed by mixing the particles (A) with conductive particles such as carbon, or by effecting chemical vapor deposition (CVD) of an organic compound gas on surfaces of the particles (A), or a combination thereof. The CVD step is preferred.

The CVD step may be effected at the same time as the heat treatment of a silicon base compound mentioned above, or CVD of an organic compound gas on surfaces of the particles (A) may be effected as a separate step. Efficient carbon coating may be performed by introducing an organic compound gas into a reactor where heat treatment of a silicon base compound is carried out. Specifically, a silicon base compound or particles (A) are subjected to CVD in an organic compound gas under a reduced pressure of 50 Pa to 30,000 Pa and at a temperature of 700 to 1,200° C. The pressure during CVD is preferably 50 Pa to 10,000 Pa, more preferably 50 to 2,000 Pa. If CVD is under a pressure in excess of 30,000 Pa, the coated material may have a more fraction of graphitic material having graphite structure, leading to a reduced battery capacity and degraded cycle performance when used as the negative electrode material in nonaqueous electrolyte secondary batteries. The CVD temperature is preferably in a range of 800 to 1,200° C., more preferably 900 to 1,100° C. At a temperature below 700° C., treatment may be inevitably, continued for a longer time. A temperature above 1,200° C. may cause fusion and agglomeration of particles during CVD treatment. Since a conductive coating is not formed at the agglomerated interface, the resulting material may suffer from degraded cycle performance when used as the negative electrode material in nonaqueous electrolyte secondary batteries. Although the treatment time may be suitably determined in accordance with the desired carbon coverage, treatment temperature, concentration (flow rate) and quantity of organic compound gas, and the like, a time of 1 to 10 hours, especially 2 to 7 hours is cost effective.

The organic compound used to generate the organic compound gas is a compound which is thermally decomposed, typically in a non-acidic atmosphere, at the heat treatment temperature to form carbon or graphite. Exemplary organic compounds include hydrocarbons such as methane, ethane, ethylene, acetylene, propane, butane, butene, pentane, isobutane, and hexane, alone or in admixture, mono- to tri-cyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene, alone or in admixture, and mixtures of the foregoing. Also, gas light oil, creosote oil and anthracene oil obtained from the tar distillation step are useful as well as naphtha cracked tar oil, alone or in admixture.

In the carbon-coated particles, the coverage (or coating weight) of carbon is preferably 0.3 to 40%, and more preferably 0.5 to 30% by weight, but not limited thereto. A carbon coverage of less than 0.3 wt % may fail to impart satisfactory conductivity, leading to degraded cycle performance when used as the negative electrode material in nonaqueous electrolyte secondary batteries. A carbon coverage of more than 40 wt % may achieve no further effect.

The particles (A) and coated particles have physical properties (e.g., particle size and surface area) which are not particularly limited. For example, an average particle size of 0.1 to 30 μm is preferred, with a range of 0.2 to 20 μm being more preferred. A BET specific surface area of 0.5 to 30 m²/g is preferred, with a range of 1 to 20 m²/g being more preferred.

### B) Polyamide-Imide Resin

The polyamide-imide resin used herein contains amide and imide groups in an amide/imide ratio of from 25/75 to 99/1 and has a weight average molecular weight of at least 10,000. Such polyamide-imide resins may be used alone or in admixture of two or more.

In the polyamide-imide resin, a ratio of the number of amide groups to the number of imide groups may be preset in terms of a proportion of polyfunctional carboxylic acid and polyfunctional carboxylic anhydride capable of reacting with polyamine or polyisocyanate to form amide and imide groups, respectively. That is, the number of amide groups may be preset from the sum of the number of carboxyl groups in polyfunctional carboxylic acid and the number of carboxyl groups (other than acid anhydride groups) in polyfunctional carboxylic anhydride whereas the number of imide groups may be preset from the number of acid anhydride groups in polyfunctional carboxylic anhydride.

In the polyamide-imide resin, the ratio of the number of amide groups to the number of imide groups, simply referred to as “amide/imide ratio,” is from 25/75 to 99/1 and preferably from 40/60 to 90/10. If the amide/imide ratio is less than 25/75, the desired 1st cycle efficiency of the secondary battery is not achievable. If the amide/imide ratio is greater than 99/1, the capacity retention of the secondary battery after repeated cycles is exacerbated, failing to provide the desired effect.

The polyamide-imide resin should have a weight average molecular weight (Mw) of at least 10,000, preferably 10,000 to 200,000, and more preferably 10,000 to 100,000. If Mw is less than 10,000, the capacity retention of the nonaqueous electrolyte secondary battery after 100 cycles is exacerbated, failing to provide the desired effect. The Mw of the polyamide-imide resin may be controlled in terms of a ratio of functional groups in monomers used and polymerization reaction conditions such as the temperature and the type and amount of the catalyst.

It is noted that the Mw of a polyamide-imide resin is determined by gel permeation chromatography (GPC). More specifically, Mw is measured by GPC system HCL-8220 (Tosoh Corp.) with columns TSKgel SuperAW (2500, 3000, 4000, 5000), using high-speed liquid chromatography DMF having 10 mmol of lithium bromide added thereto as the elute, and polyethylene glycol as the standard solution.

The method of preparing a polyamide-imide resin is described. The polyamide-imide resin used herein may be prepared by reacting (I) an acid component selected from polyfunctional carboxylic anhydrides, polyfunctional carboxylic acids and mixtures thereof with (II) a component selected from polyfunctional isocyanates, polyfunctional amines and mixtures thereof. The polyfunctional carboxylic anhydride (a) and polyfunctional carboxylic acid (b) may be used in such amounts to give a molar ratio: 100/0≦a/b<0/100. The number ratio of amide to imide groups in the polyamide-imide resin may be preset by the above-mentioned measure. In one example, a number ratio of amide to imide groups, i.e., an amide/imide ratio of 25/75 may be set by providing (a)/(b)=75/25 if component (a) is tetrafunctional carboxylic dianhyride and component (b) is difunctional carboxylic acid, or (a)/(b)=100/0 if component (a) is a 1/1 mixture of tetrafunctional carboxylic dianhyride and trifunctional carboxylic anhydride and component (b) is difunctional carboxylic acid. In another example, a number ratio of amide to imide groups, i.e., an amide/imide ratio of 99/1 may be set by providing (a)/(b)=1/99 if component (a) is tetrafunctional carboxylic dianhyride and component (b) is difunctional carboxylic acid, or (a)/(b)=1/74 if component (a) is a 1/1 mixture of tetrafunctional carboxylic dianhyride and trifunctional carboxylic anhydride and component (b) is difunctional carboxylic acid. These examples are merely exemplary of settings and not to be construed as limiting.

Suitable polyfunctional carboxylic anhyrides include compounds having a carboxylic anhydride group and a carboxyl group and compounds having a plurality of carboxylic anhydride groups, for example, aromatic polyfunctional carboxylic anhyrides such as trimellitic anhydride, pyromellitic dianhydride, benzophenonetetracarboxylic dianhyride, diphenylsulfonetetracarboxylic dianhydride, and oxydiphthalic dianhydride, and alicyclic polyfunctional carboxylic anhyrides such as 1,3,4-cyclohexanetricarboxylic acid-3,4-anhydride and 1,2,3,4-butanetetracarboxylic dianhydride, which may be used alone or in admixture of two or more. Derivatives of the foregoing are also useful, for example, alkyl esters of trimellitic anhydride, and trimellitic acid or trimellitic chloride capable of forming an intramolecular acid anhydride. Of these, trimellitic anhydride is preferred for cost and availability. Understandably, when a compound having both acid anhydride and carboxyl group as functional groups such as trimellitic anhydride is used, a polyamide-imide resin may be obtained without using polyfunctional carboxylic acid.

Suitable polyfunctional carboxylic acids include aromatic polyfunctional carboxylic acids such as terephthalic acid, isophthalic acid, phthalic acid, naphthalene dicarboxylic acid, diphenylmethane dicarboxylic acid, diphenyl ether dicarboxylic acid, diphenyl sulfone dicarboxylic acid, and pyromellitic acid, aliphatic polyfunctional carboxylic acids such as succinic acid, adipic acid, sebacic acid, dodecanedioic acid, and 1,2,3,4-butanetetracarboxylic acid, unsaturated aliphatic polyfunctional carboxylic acids such as maleic acid and fumaric acid, and alicyclic polyfunctional carboxylic acids such as 4-cyclohexene-1,2-dicarboxylic acid, which may be used alone or in admixture of two or more. Derivatives of the foregoing, for example, esters such as dimethyl terephthalate, and acid anhydrides such as phthalic anhydride are also useful. Of these, terephthalic acid, isophthalic acid, adipic acid, and sebacic acid are preferred for cost and availability, with isophthalic acid being most preferred.

Suitable polyfunctional isocyanates include diphenylmethane diisocyanate, tolylene diisocyanate, tolidine diisocyanate, xylylene diisocyanate, naphthalene diisocyanate, isophorone diisocyanate, hexamethylene diisocyanate, dicyclohexane methane diisocyanate, and polyisocyanates such as oligomers of diphenylmethane diisocyanate and oligomers of tolylene diisocyanate, which may be used alone or in admixture of two or more. Of these, diphenylmethane diisocyanate is preferred, with 4,4′-diphenylmethane diisocyanate being most preferred for cost and availability. Derivatives of the foregoing, for example, block isocyanates of phenol, xylenol, ketones or the like are also useful.

Suitable polyfunctional amines include phenylene diamine, diaminodiphenylmethane, methylene diamine, xylylene diamine, naphthalene diamine, tolylene diamine, tolidine diamine, and hexamethylene diamine, which may be used alone or in admixture of two or more. Of these, diaminodiphenylmethane is preferred, with 4,4′-diaminodiphenylmethane being most preferred for cost and availability.

The polyamide-imide resin may be prepared by standard processes such as isocyanate process and acid chloride process. The isocyanate process is preferred for reactivity and cost.

When polyamide-imide resins are prepared, polymerization may be effected in solvents. Suitable solvents include amide-containing polar solvents such as N-methyl-2-pyrrolidone (NMP), N-ethyl-2-pyrrolidone, N,N′-dimethylacetamide (DMAc), and N,N′-dimethylformamide (DMF), lactone solvents such as y-butyrolactone and δ-valerolactone, ester solvents such as dimethyl adipate and dimethyl succinate, phenolic solvents such as cresol and xylenol, ether solvents such as diethylene glycol monomethyl ether, sulfur-containing solvents such as dimethyl sulfoxide, and aromatic hydrocarbon solvents such as xylene and petroleum naphtha. Inter alia, NMP is most preferred because it has a dissolving power and facilitates reaction. These solvents may be used alone or in combination of two or more. A catalyst may be used in polymerization. Suitable catalysts include amines such as triethylene diamine and pyridine, phosphorus-based catalysts such as triphenyl phosphate and triphenyl phosphite, and metal catalysts such as zinc octenoate and tin octenoate. The amount of the catalyst added is not particularly limited as long as it does not interfere with the reaction. Preferably the catalyst is used in an amount of 0.1 to 1% by weight based on the resin.

Although the polymerization temperature is not particularly limited, the temperature is preferably 50 to 200° C., more preferably 80 to 150° C. At temperatures below 50° C., reaction may take place slowly and a long time may be necessary until the reaction is completed. Temperatures above 200° C. may increase the probability of side reaction, with an increased possibility that the polyamide-imide resin becomes three-dimensional, indicating gelation of the reaction system.

When a polyfunctional amine is used, an amic acid is first formed, which is followed by a cyclization step to form an imide ring. This cyclization step may be performed in the polymerization reaction system of polyamide-imide resin. Alternatively, once the resin solution in amic acid state is taken out, cyclization may be performed during the subsequent molding step.

### Negative Electrode

The negative electrode for nonaqueous electrolyte secondary batteries according to the invention is defined as comprising (A) particles having Si dispersed in SiO₂ and (B) a polyamide-imide resin, which are defined above. Component (A) is preferably present in an amount of 70 to 99.9% by weight and more preferably 80 to 99% by weight based on the weight of the electrode. Component (B) is preferably present in an amount of 0.1 to 30% by weight and more preferably 1 to 20% by weight based on the weight of the electrode. The amount is calculated as a solid.

A conductive agent such as graphite may be added to the negative electrode. The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins. The conductive agent is preferably added in an amount of 0.1 to 30% by weight and more preferably 1 to 10% by weight based on the weight of the electrode.

In addition to the polyamide-imide resin, a viscosity modifier such as carboxymethyl cellulose, poly(sodium acrylate), another acrylic polymer or a fatty acid ester may be added. The amount of the viscosity modifier added is typically 0.01 to 10% by weight based on the weight of the electrode.

From the negative electrode material, a negative electrode in shaped form may be prepared, for example, by the following procedure. The negative electrode is prepared by combining particles (A), polyamide-imide resin (B), and optional additives such as conductive agent, kneading them in a solvent (suitable for dissolution or dispersion of the binder) such as NMP or water to form a slurry mix, and applying the mix in sheet form to a current collector. The current collector used herein may be a foil of any material which is commonly used as the negative electrode current collector, for example, a copper or nickel foil while the thickness and surface treatment thereof are not particularly limited. The method of shaping or molding the slurry mix into a sheet is not limited, and any well-known method may be used.

### Nonaqueous Electrolyte Secondary Battery

A lithium ion secondary battery may be constructed using the negative electrode defined above. The lithium ion secondary battery is characterized by the use of the negative electrode while the materials of the positive electrode, electrolyte, nonaqueous solvent, separator, current collector and the battery design may be well-known ones and are not particularly limited. For example, the positive electrode active material used herein may be selected from transition metal oxides such as LiCoO₂, LiNiO₂LiMn₂O₄, Li(Mn_{1/3}Ni_{1/3}Co_{1/3})O₂, V₂O₅, MnO₂, TiS₂ and MoS₂, and chalcogen compounds. The electrolytes used herein may be lithium salts such as lithium hexafluorophosphate and lithium perchlorate in nonaqueous solution form. Examples of the nonaqueous solvent include propylene carbonate, ethylene carbonate, dimethoxyethane, γ-butyrolactone, 2-methyltetrahydrofuran, dimethyl carbonate, diethyl carbonate, methyl ethyl carbonate, vinylene carbonate, and fluoroethylene carbonate, alone or in admixture. Other various nonaqueous electrolytes and solid electrolytes may also be used.

The inventive negative electrode may also be used for electrochemical capacitors. The electrochemical capacitor is characterized by comprising the negative electrode described above, while other materials such as electrolyte and separator and capacitor design are not particularly limited. Examples of the electrolyte used include nonaqueous solutions of lithium salts such as lithium hexafluorophosphate, lithium perchlorate, lithium borofluoride, and lithium hexafluoroarsenate, and exemplary nonaqueous solvents include propylene carbonate, ethylene carbonate, dimethyl carbonate, diethyl carbonate, dimethoxyethane, γ-butyrolactone, and 2-methyltetrahydrofuran, alone or a combination of two or more. Other various nonaqueous electrolytes and solid electrolytes may also be used.

### EXAMPLE

Examples of the invention are given below by way of illustration and not by way of limitation.

### Example 1

### Preparation of Conductive Particles

A batchwise heating furnace was charged with 100 g of particles of silicon oxide SiOₓ (x=1.01) having an average particle size of 5 _{g}um and a BET specific surface area of 3.5 m²/g. The furnace was evacuated to vacuum by means of an oil sealed rotary vacuum pump while it was heated to 1,100° C. Once the temperature was reached, CH₄ gas was fed at 0.3 NL/min through the furnace where carbon coating treatment was carried out for 5 hours. A reduced pressure of 800 Pa was kept during the treatment. At the end of treatment, the furnace was cooled down, recovering 97.5 g of black particles, i.e., carbon-coated particles having Si dispersed in SiO₂. The black particles had an average particle size of 5.2 μm and a BET specific surface area of 6.5 m²/g, and were conductive due to a carbon coverage of 5.1 wt % based on the black particles.

### Preparation of Polyamide-Imide Resin Solution With Amide/Imide Ratio=50/50

In a nitrogen gas stream, a 2-L four-necked flask was charged with 192.0 g (1.0 mole) of trimellitic anhydride as polyfunctional carboxylic anhydride, 250.0 g (1.0 mole) of 4,4′-diphenylmethane diisocyanate as polyfunctional isocyanate, and 708 g of NMP and heated at 100° C. for 3 hours. Thereafter, the temperature was raised to 120° C., and reaction was run at the temperature for 6 hours. The reaction mixture was diluted with 118 g of NMP to give a polyamide-imide resin solution. The resin had a weight average molecular weight (Mw) of 18,000 on GPC analysis.

### Preparation of Negative Electrode

A slurry was formed by combining 90 parts by weight of the conductive particles with 10 parts by weight of the polyamide-imide resin solution and adding 20 parts by weight of NMP thereto. The slurry was coated onto a copper foil of 12 μm thick to different thickness via a varying gap and dried at 80° C. for one hour. Using a roller press, the coated foil was shaped under pressure into an electrode sheet. The electrode sheet was vacuum dried at 350° C. for 1 hour, after which a piece of 2 cm² was punched out as the negative electrode.

### Preparation of Positive Electrode

A slurry was formed by combining 94 parts by weight of LiCoO₂ (trade name Cellseed C-10 by Nippon Chemical Industrial Co., Ltd.) with 3 parts by weight of acetylene black (by Denki Kagaku Kogyo K. K.) and 3 parts by weight of polyvinylidene fluoride (PVdF, trade name KF-Polymer by Kureha Corp.) and adding 30 parts by weight of NMP thereto. The slurry was coated onto an aluminum foil of 15 μm thick and dried at 80° C. for one hour. Using a roller press, the coated foil was shaped under pressure into an electrode sheet. The electrode sheet was vacuum dried at 150° C. for 10 hours, after which a piece of 2 cm² was punched out as the positive electrode.

### Cell Test

To evaluate the charge/discharge characteristics of the negative electrode, a test lithium ion secondary cell was constructed in an argon glove box. Metallic lithium was used as the counter electrode. The electrolyte solution used was a nonaqueous electrolyte solution of lithium hexafluorophosphate in a 1/1 (by volume) mixture of ethylene carbonate and diethyl carbonate in a concentration of 1 mol/liter. The separator used was a porous polyethylene film of 30 μm thick.

The lithium ion secondary cell thus constructed was taken out of the glove box and kept in a low-temperature thermostatic chamber at 25° C. Using a secondary cell charge/discharge tester (Nagano K. K.), a charge/discharge test was carried out on the cell. Charging was conducted with a constant current flow of 0.15 mA/cm² until the voltage of the test cell reached 0.005 V. Discharging was conducted with a constant current flow of 0.15 mA/cm² and terminated when the cell voltage reached 1.4 V. A 1st cycle charge/discharge capacity and a 1st cycle efficiency (given as 1st cycle discharge capacity divided by 1st cycle charge capacity) were determined.

Another test lithium ion secondary cell was constructed in an argon glove box using the positive electrode prepared from LiCoO₂, acetylene black and PVdF, and the negative electrode prepared from the conductive particles and polyamide-imide resin. The capacities of the positive and negative electrodes were adjusted such that the 1st cycle efficiency might be substantially equal to that of the test cell using lithium counter electrode. The electrolyte solution used was a nonaqueous electrolyte solution of lithium hexafluorophosphate in a 1/1 (by volume) mixture of ethylene carbonate and diethyl carbonate in a concentration of 1 mol/liter. The separator used was a porous polyethylene film of 30 μm thick.

The lithium ion secondary cell thus constructed was taken out of the glove box and kept in a low-temperature thermostatic chamber at 25° C. Using a secondary cell charge/discharge tester (Nagano K. K.), a charge/discharge test was carried out on the cell. Charging was conducted with a constant current flow equivalent to 0.5 CmA until the voltage of the test cell reached 4.2 V. At the point of time reaching 4.2 V, the current flow was reduced, and constant voltage charging was continued to an equivalent of 0.1 CmA. Discharging was conducted with a constant current flow equivalent to 0.5 CmA and terminated when the cell voltage reached 2.5 V. This charge/discharge test was repeated 100 cycles, completing a 100 cycle charge/discharge test on the lithium ion secondary cell to be evaluated. Table 1 reports the 1st cycle discharge capacity, the discharge capacity after 100 cycles, and the capacity retentivity after 100 cycles (given as 100th cycle discharge capacity divided by 1st cycle discharge capacity).

### Example 2

### Preparation of Polyamide-Imide Resin Solution With Amide/Imide Ratio=75/25

A polyamide-imide resin solution was prepared as in Example 1 aside from using 96.0 g (0.5 mole) of trimellitic anhydride as polyfunctional carboxylic anhydride, 83.0 g (0.5 mole) of isophthalic acid as polyfunctional carboxylic acid, 250.0 g (1.0 mole) of 4,4′-diphenylmethane diisocyanate as polyfunctional isocyanate, and 708 g of NMP. A cell test was carried out as in Example 1 aside from using the polyamide-imide resin solution prepared herein. The results are also shown in Table 1.

### Example 3

### Preparation of Polyamide-Imide Resin Solution With Amide/Imide Ratio=87.5/12.5

A polyamide-imide resin solution was prepared as in Example 1 aside from using 48.0 g (0.25 mole) of trimellitic anhydride as polyfunctional carboxylic anhydride, 124.5 g (0.75 mole) of isophthalic acid as polyfunctional carboxylic acid, 250.0 g (1.0 mole) of 4,4′-diphenylmethane diisocyanate as polyfunctional isocyanate, and 708 g of NMP. A cell test was carried out as in Example 1 aside from using the polyamide-imide resin solution prepared herein. The results are also shown in Table 1.

### Example 4

### Preparation of High-Molecular-Weight Polyamide-Imide Resin Solution With Amide/Imide Ratio=87.5/12.5

A polyamide-imide resin solution was prepared as in Example 1 aside from using 48.0 g (0.25 mole) of trimellitic anhydride as polyfunctional carboxylic anhydride, 83.0 g (0.5 mole) of isophthalic acid as polyfunctional carboxylic acid, 250.0 g (1.0 mole) of 4,4′-diphenylmethane diisocyanate as polyfunctional isocyanate, and 708 g of NMP and effecting reaction at an elevated temperature of 150° C. A cell test was carried out as in Example 1 aside from using the polyamide-imide resin solution prepared herein. The results are also shown in Table 1.

### Example 5

### Preparation of High-Molecular-Weight Polyamide-Imide Resin Solution With Amide/Imide Ratio=75/25

A polyamide-imide resin solution was prepared as in Example 1 aside from using 96.0 g (0.5 mole) of trimellitic anhydride as polyfunctional carboxylic anhydride, 83.0 g (0.5 mole) of isophthalic acid as polyfunctional carboxylic acid, 250.0 g (1.0 mole) of 4,4′-diphenylmethane diisocyanate as polyfunctional isocyanate, and 708 g of NMP and effecting reaction at an elevated temperature of 140° C. A cell test was carried out as in Example 1 aside from using the polyamide-imide resin solution prepared herein. The results are also shown in Table 1.

### Example 6

### Preparation of Polyamide-Imide Resin Solution With Amide/Imide Ratio=40/60

A polyamide-imide resin solution was prepared as in Example 1 aside from using 92.16 g (0.48 mole) of trimellitic anhydride and 38.64 g (0.12 mole) of benzophenonetetracarboxylic dianhydride as polyfunctional carboxylic anhydride, 150.0 g (0.6 mole) of 4,4′-diphenylmethane diisocyanate as polyfunctional isocyanate, and 912 g of NMP and effecting reaction at an elevated temperature of 180° C. A cell test was carried out as in Example 1 aside from using the polyamide-imide resin solution prepared herein. The results are also shown in Table 1.

### Comparative Example 1

### Preparation of Low-Molecular-Weight Polyamide-Imide Resin Solution With Amide/Imide Ratio=50/50

A polyamide-imide resin solution was prepared as in Example 1 aside from using 192.0 g (1.0 mole) of trimellitic anhydride as polyfunctional carboxylic anhydride, 237.5 g (0.95 mole) of 4,4′-diphenylmethane diisocyanate as polyfunctional isocyanate, and 708 g of NMP. A cell test was carried out as in Example 1 aside from using the polyamide-imide resin solution prepared herein. The results are also shown in Table 1.

### Comparative Example 2

### Preparation of Low-Molecular-Weight Polyamide-Imide Resin Solution With Amide/Imide Ratio=75/25

A polyamide-imide resin solution was prepared as in Example 1 aside from using 96.0 g (0.5 mole) of trimellitic anhydride as polyfunctional carboxylic anhydride, 83.0 g (0.5 mole) of isophthalic acid as polyfunctional carboxylic acid, 237.5 g (0.95 mole) of 4,4′-diphenylmethane diisocyanate as polyfunctional isocyanate, and 708 g of NMP. A cell test was carried out as in Example 1 aside from using the polyamide-imide resin solution prepared herein. The results are also shown in Table 1.

### Comparative Example 3

### Preparation of Polyamide-Imide Resin Solution With Amide/Imide Ratio=20/80

A polyamide-imide resin solution was prepared as in Example 1 aside from using 23.04 g (0.12 mole) of trimellitic anhydride and 57.96 g (0.18 mole) of benzophenonetetracarboxylic dianhydride as polyfunctional carboxylic anhydride, 150.0 g (0.6 mole) of 4,4′-diphenylmethane diisocyanate as polyfunctional isocyanate, and 1166 g of NMP and effecting reaction at an elevated temperature of 180° C. A cell test was carried out as in Example 1 aside from using the polyamide-imide resin solution prepared herein. The results are also shown in Table 1.

### Comparative Example 4

### Polyimide

A cell test was carried out as in Example 1 aside from using a polyimide resin U-vanish A (Ube Industries, Ltd.) as the binder. The results are also shown in Table 1.

### Comparative Example 5

### Polyamide

A polyamide resin solution was prepared as in Example 1 aside from using 83.0 g (0.5 mole) of isophthalic acid and 101.0 g (0.5 mole) of sebacic acid as polyfunctional carboxylic acid, 75.0 g (0.3 mole) of 4,4′-diphenylmethane diisocyanate and 121.8 g (0.7 mole) of tolylene diisocyanate as polyfunctional isocyanate, and 439 g of NMP and effecting reaction at an elevated temperature of 160° C. A cell test was carried out as in Example 1 aside from using the polyamide-imide resin solution prepared herein. The results are also shown in Table 1.

### Comparative Example 6

A cell test was carried out as in Example 1 aside from using a polyvinylidene fluoride resin KF-Polymer (Kureha Corp.) as the binder. The results are also shown in Table 1.

It is noted that the result of the test using LiCoO₂ counter electrode is reported in terms of a capacity (mAh) per cell. Since Li is regarded as having a sufficiently high capacity relative to the negative electrode combined with Li, this test is suitable in computing the capacity of the negative electrode of interest.

TABLE 1

| | | | | 1st cycle charge capacity | | 1st cycle charge capacity | Capacity |
|---|---|---|---|---|---|---|---|
| | | | | (upper) and 1st cycle discharge | 1st cycle | (upper) and 100th cycle discharge | retentivity |
| | | Amide/imide | | capacity (lower) vs. Li counter | efficiency | capacity (lower) vs. LiCoO₂ counter | after 100 |
| | | ratio | Mw | electrode (mAh/g of mix) | (%) | electrode (mAh) | cycles (%) |
| Example | 1 | 50/50 | 18,000 | 1720 | 74.8 | 5.41 | 88 |
| | | | | 1287 | | 4.76 | |
| | 2 | 75/25 | 16,000 | 1712 | 75.0 | 5.42 | 89 |
| | | | | 1284 | | 4.83 | |
| | 3 | 87.5/12.5 | 11,000 | 1696 | 76.0 | 5.50 | 88 |
| | | | | 1289 | | 4.84 | |
| | 4 | 87.5/12.5 | 93,000 | 1690 | 76.2 | 5.51 | 89 |
| | | | | 1288 | | 4.90 | |
| | 5 | 75/25 | 88,000 | 1681 | 75.9 | 5.49 | 89 |
| | | | | 1276 | | 4.88 | |
| | 6 | 40/60 | 15,000 | 1734 | 74.0 | 5.35 | 89 |
| | | | | 1283 | | 4.76 | |
| Comparative | 1 | 50/50 | 9,000 | 1729 | 74.3 | 5.37 | 83 |
| Example | | | | 1285 | | 4.46 | |
| | 2 | 75/25 | 7,000 | 1709 | 74.8 | 5.41 | 81 |
| | | | | 1279 | | 4.38 | |
| | 3 | 20/80 | 15,000 | 1760 | 73.0 | 5.28 | 86 |
| | | | | 1285 | | 4.54 | |
| | 4 | 0/100 | | 1791 | 72.4 | 5.23 | 88 |
| | | | | 1297 | | 4.61 | |
| | 5 | 100/0 | 50,500 | 1680 | 75.0 | 5.42 | 70 |
| | | | | 1260 | | 3.79 | |
| | 6 | | | 1689 | 73.0 | 5.28 | 3 |
| | | | | 1233 | | 0.16 | |

The electrodes using low molecular weight polyamide-imide resins (Comparative Examples 1 and 2), polyamide resin (Comparative Example 5), and polyvinylidene fluoride (Comparative Example 6) show a low capacity retentivity after 100 cycles, and the electrode using a polyamide-imide resin with an amide/imide ratio of 20/80 (Comparative Example 3) is somewhat inferior in capacity retentivity after 100 cycles and 1st cycle efficiency to the inventive electrodes. A comparison of Example 1 with Comparative Example 4 shows a 1st cycle efficiency difference of 2.4% and a discharge capacity difference of 10 mAh/g versus Li counter electrode. When the negative electrode is combined with the positive electrode, a positive electrode matching with the initial efficiency must be provided. The positive electrode in Comparative Example 4 is required to match with an initial efficiency extra of 494 mAh/g whereas the positive electrode in Example 1 is required to match with an initial efficiency extra of 433 mAh/g. Example 1 allows for fabrication of a cell with a higher capacity.

Japanese Patent Application No. 2009-211257 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A negative electrode for nonaqueous electrolyte secondary batteries, comprising
(A) particles having Si dispersed in SiO₂ and
(B) a polyamide-imide resin which contains amide and imide groups in an amide/imide ratio of 25/75 to 99/1 and has a weight average molecular weight of at least 10,000.

2. The negative electrode of claim 1 wherein the particles (A) are further coated with carbon.

3. The negative electrode of claim 1 wherein components (A) and (B) are present in an amount of 70 to 99.9% by weight and 0.1 to 30% by weight based on the weight of the electrode, respectively.

4. A lithium ion secondary battery comprising the negative electrode of claim 1.
